(19) United States
(12) Patent Application Publication
(10) Pub. No.: US 2016/0167058 A1
(43) Pub. Date: Jun. 16, 2016

(54) Apparatus and Method for Separating Heavy Metals from Sand

(71) Applicant: Barry Sheldon Collier, Langley (CA)

(72) Inventor: Barry Sheldon Collier, Langley (CA)

(21) Appl. No.: 14/971,214

(22) Filed: Dec. 16, 2015

Related U.S. Application Data
(60) Provisional application No. 62/092,256, filed on Dec. 16, 2014.

(51) Int. Cl. B03B 5/52; B07B 13/11; B03B 5/56

(52) U.S. Cl. CPC B03B 5/52; B03B 5/56; B07B 13/11

(57) ABSTRACT

An apparatus for separating a target element from a mixed material uses a barrel with one or more helical threads on its surface. The barrel is rotated as the mixed material is introduced into the barrel via a hopper. A water nozzle sprays the mixed material as the mixed material is added so that the target element moves towards the top of the barrel while other parts of the mixed materials are washed towards the bottom. In some embodiments the barrel is made of a color that contrasts the target material.

### CROSS-REFERENCE TO RELATED APPLICATIONS

This application is related to and claims priority from U.S. Provisional Application Ser. No. 62/092,256 having a filing date of Dec. 16, 2014, entitled “Apparatus and Method for Separating Heavy Metals from Sand”. The '256 application is hereby incorporated by reference herein in its entirety.

### FIELD OF THE INVENTION

The present invention relates to apparatuses and methods for separating gold or other heavy metals from sand, black sand, ore or other materials in which the metals occur.

### BACKGROUND OF THE INVENTION

Placer mining is the mining of alluvial deposits for minerals. Alluvial deposits typically include fine particles of silt or clay, and larger particles of sand and gravel. Placer mining can be used for the extraction of precious metals such as gold. Panning is a form of placer mining for extracting gold and precious metals from alluvial deposits using a pan. The panning action causes materials with low specific gravity to spill out the top of the pan while materials with higher specific gravity sink to the bottom. The higher specific gravity materials can include black sand (a magnetic mixture of fine sands) and heavy metals such as gold.

U.S. Pat. No. 5,275,294 describes a rotating pan with spiral ribs that coil inwardly to the pan's center for separating smaller particles, including small particles of gold.

An example of another device that can be used to separate heavy metals from sand is a riffle board. Riffle boards have ridges designed to trap and retain heavy metals, as material containing the metals is washed over the boards. Riffle boards can be placed in a stream. Materials with low specific gravities tend to be washed off the board into the stream while materials with higher specific gravities tend to be trapped and retained by the ridges on the riffle boards. U.S. Pat. No. 2,053,802 describes a means for concentrating unclassified materials and for classifying materials having different specific gravities using a rotating riffle.

Other devices for separating heavy metals use a tube or drum comprising riffles to carry material and collect a concentrate which is mostly black sand and other heavy material. U.S. Pat. No. 2,608,299 describes a rotary drum concentrator with riffles designed to carry material to one end of the rotary drum. U.S. Pat. No. 4,512,881 describes a rotating drum with an inner spiral protuberance for moving materials from a receiving end to a discharge end, and thereby recovering metal values from ore.

Other devices use a rotating drum with a vane, or an apparatus with a fin, configured to concentrate placer gold. U.S. Pat. No. 2,164,364 describes a device for concentrating and refining placer gold ores in which the gold occurs as “flour gold”. The device has a trommel screen and a conveyor with a helical fin. U.S. Pat. No. 4,159,242 describes an apparatus for separating particles based on their size and specific gravity, comprising a rotating cylinder with helical ribbon flights for moving the desired material out of the slurry. U.S. Pat. No. 5,108,584 describes a rotating drum mounted at an angle to the horizontal and comprising a spiral vane extending the length of the drum's inner surface. The drum comprises an inner barrel into which a spray of water is directed. The machine works such that large tailings are discharged from the lower end of the inner barrel, and fine tailings are discharged from the outer drum. The heaviest and finest material contains the desired heavy metal and is carried by the spiral to be discharged from the upper end of the outer drum.

Other devices use magnetic means to separate placer gold from sand. U.S. Pat. No. 6,138,833 to Matsufuji describes a method and system for mining placer gold. The Matsufuji method comprises two steps—a first step to generate an intermediate mixture of placer gold and sand of a higher specific gravity than the remainder of the sand—and a second step to separate placer gold from the intermediate mixture of gold and sand by means of a magnetic force.

While each of these devices and methods are useful for their intended purpose, there remains a need for improved apparatuses and methods for separating fine gold from sand. In particular, it is desirable that the improved apparatus and methods are capable of separating fine gold rather than merely concentrating it. Such apparatuses can be mobile so that it can be transported to work sites, and can also operate in a continuous mode wherein material can be added in a substantially continuous fashion without interrupting operation. Such apparatus can also be adjustable, and configurable for different types of material and materials of varying specific gravity.

### SUMMARY OF THE INVENTION

The apparatus for separating a target element, such as gold, from a mixed material includes a barrel with one or more helical threads on the inside surface of the barrel. In some embodiments the thread extends from the upper rim of the barrel to the lower rim of the barrel. In other or the same embodiments, the barrel includes several substantially identical threads. In some embodiments, the number of threads is eight.

In at least one embodiment, the helical thread is defined by a helical rib protruding from the inside surface of the barrel, where the helical rib has a first surface substantially perpendicular to the inner surface of the barrel; and a second surface subtending an angle of approximately sixty-eight degrees with the inside surface of the barrel.

A drive mechanism can rotate the barrel about its longitudinal axis, and the longitudinal axis inclined at an angle to a horizontal plane such that the upper rim is positioned higher than the lower rim. In some embodiments the barrel rotates between eighteen and twenty-two revolutions per minute. In other or the same embodiments, the angle is between twelve and twenty-five degrees. In at least one embodiment, this angle can be adjusted during operation of the apparatus.

In some embodiments, gold-bearing material, or other mixed material, is introduced into the barrel via a hopper. The gold-bearing material is washed with water directed at the threads from a water spray nozzle inserted into the barrel. In some embodiments, the water spray nozzle is oriented to direct a continuous stream of water at the inside surface of the barrel between the floor and ceiling of said barrel and at an offset angle from said longitudinal axis. In some embodiment the offset angle is approximately sixty degrees.

The handedness of at least one of the threads is selected to move material upward. Fine gold is carried by the threads to the upper rim of the barrel where it is collected. Black sand and other waste is washed into the threads and washed down to the lower rim of the barrel where it is discarded.

In some embodiments, the specific gravity of the target element is greater than four. In at least some embodiments the color of the barrel contrasts with the color of the target element and/or the color of the mixed material. In some embodiments, the barrel is formed by CNC machining.

A method for operating the apparatus includes: adjusting the angle to a first angle of inclination activating the drive mechanism to cause said barrel to rotate at a substantially constant rotational rate; introducing a continuous stream of water from said water spray nozzle; introducing a quantity of mixed material into the barrel via the hopper, the mixed material introduced into the continuous stream of water; recovering a concentrate discharged at the upper rim, wherein the concentrate contains said target element at a higher concentration than the mixed material; adjusting the angle to a second angle of inclination; re-introducing the concentrated mixed material into the barrel via the hopper, the concentrated mixed material introduced into the stream of water; and recovering the target element at the upper rim. In some embodiments, the first angle of inclination is between twelve degrees and eighteen degrees and the second angle of inclination is between eighteen degrees and twenty-five degrees.

### BRIEF DESCRIPTION OF THE DRAWINGS

FIG. 1 is an isometric view of an apparatus for separating fine gold from black sand.

FIG. 2A is an end view of the barrel of FIG. 1.

FIG. 2B is a cross-sectional side view of the barrel of FIG. 1.

FIG. 2C is a detailed view of a first region of FIG. 2B.

FIG. 2D is a detailed view of a second region of FIG. 2B.

FIG. 2E is a schematic illustrating a thread geometry suitable for extracting fine gold from black sand.

FIG. 3 is an exploded schematic of a portion of the apparatus of FIG. 1.

FIG. 4 is an exploded schematic of a portion of the apparatus of FIG. 1.

FIG. 5 is a perspective view of an apparatus for separating fine gold from black sand.

FIG. 6 is another perspective view of the apparatus of FIG. 5 for separating fine gold from black sand.

FIG. 7 is a perspective view of an upper end of the apparatus of FIGS. 5 and 6.

FIG. 8 is another perspective view of an upper end of the apparatus of FIGS. 5 and 6.

FIG. 9 is a schematic illustrating the position of the water spray nozzle.

FIG. 10 is a flow chart illustrating a method for separating fine gold from black sand.

### DETAILED DESCRIPTION OF CERTAIN EMBODIMENT(S)

The present apparatus and method relates to apparatuses and methods for separating gold or other heavy metals from sand, black sand, ore or other materials in which the metals occur.

In referring to separating gold from sand, it is understood that the apparatus and method described herein can be used to separate various heavy or precious metals from alluvial deposits, granular or pulverized ore or other similar materials in which the metals can be found.

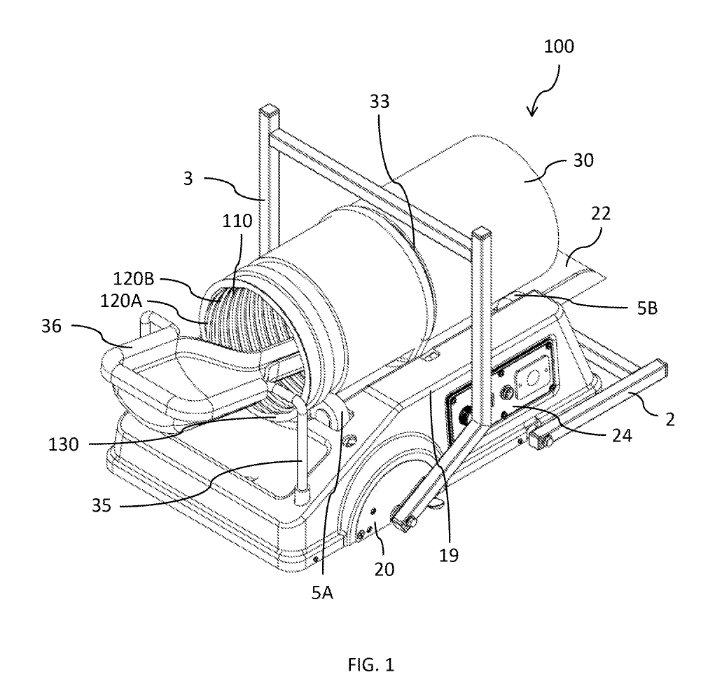

FIG. 1 is an isometric view of apparatus 100 for separating fine gold from black sand. Apparatus 100 comprises barrel 30. In an example embodiment, barrel 30 is approximately two feet (2′) long and has an outer diameter of approximately eleven inches (11″) with a one-half inch (½″) wall. In another embodiment the outer diameter is approximately (9″).

In operation, barrel 30 is inclined to the horizontal and made to rotate about its longitudinal axis. In some embodiments, barrel 30 can be made to rotate by connecting barrel 30 to a drive mechanism and a motor (not shown in FIG. 1).

Gold-bearing material is introduced into barrel 30 via hopper 36 which is held in place by hopper holder 35. Inside surface 110 of barrel 30 has one or more helical threads 120 running parallel to each other from one end of barrel 30 to the other. FIG. 1 shows two helical threads 120A and 120B. In an example embodiment, inside surface 110 of barrel 30 can comprise eight (8) helical threads.

FIG. 1 also illustrates rear leg assembly 2 and front leg assembly 3.

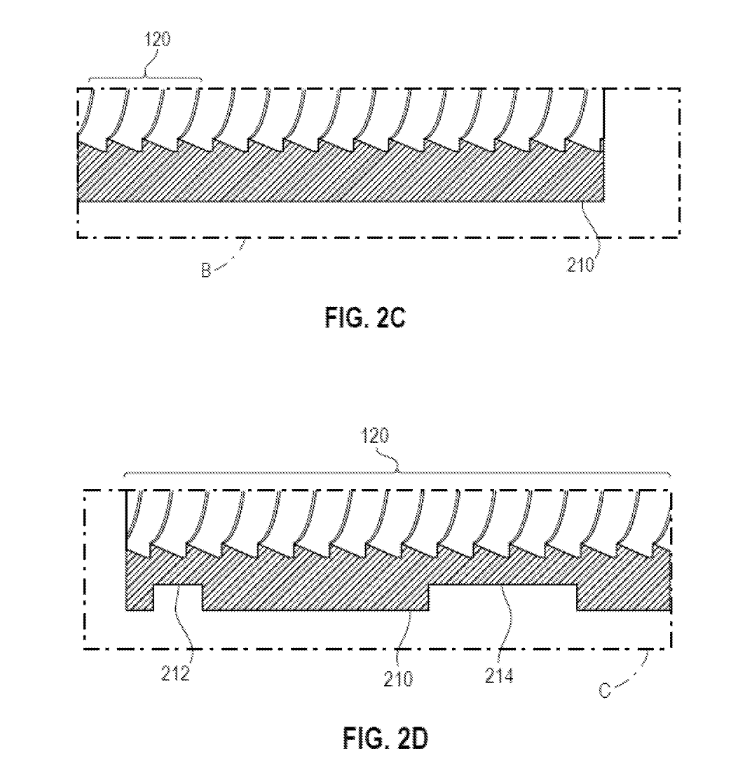

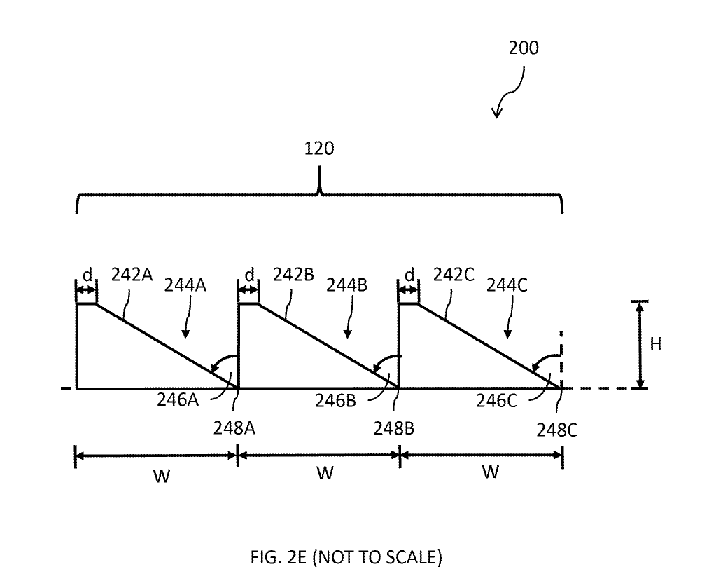

As shown in FIGS. 3 and 4, apparatus 100 further comprises motor 31 that, in conjunction with V-belt pulley 32 and belt 33, is configured to rotate barrel 30. Barrel 30 can roll on four rigid casters 5A through 5D (5C and 5D not visible in FIG. 1) as it rotates about its longitudinal axis.

In some embodiments, inside surface 110 of barrel 30 comprises one or more continuous seamless threads 120 (such as threads 120A and 120B of FIG. 1). Threads 120 can be formed to be continuous and have no interruption or discontinuity such as might occur if there was a seam on inside surface 110 of barrel 30. It has been found that it is beneficial for separation and recovery of fine gold from black sand for threads 120 to be formed as a single part, and for the thread edges to be sharp and have no or minimal burrs or rough edges.

Threads 120 can be formed by machining, milling, stamping, embossing, molding or other suitable fabrication methods depending on the material from which barrel 30 is made. In one embodiment, barrel 30 is formed by CNC (computer numerical control) machining.

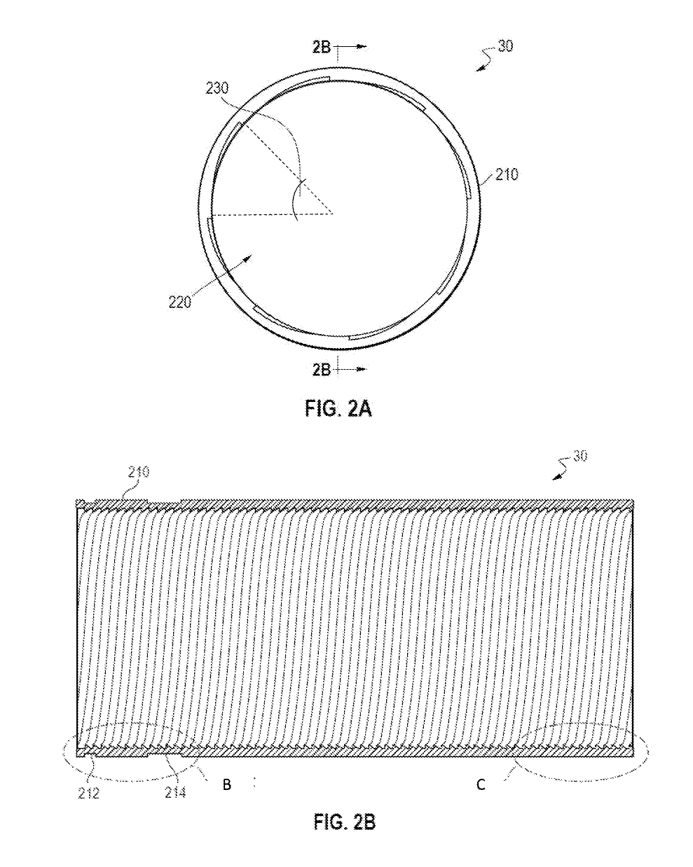

FIG. 2A is an end view of barrel 30 of FIG. 1. Barrel 30 comprises wall 210 in the shape of a cylinder open at both ends and enclosing interior volume 220.

Inside surface 110 of barrel 30 comprises one or more threads 120. The starting positions of threads 120 are spaced apart from one another by angle 230 around upper rim 130 of barrel 30. In the example embodiment shown in FIG. 2A, inside surface of barrel 30 comprises eight (8) threads 120, the starting positions of threads 120 spaced apart from one another around upper rim 130 of FIG. 1.

FIG. 2B is a cross-sectional view of barrel 30 of FIG. 1. The cross-section view is taken along line 2B of FIG. 2A. Inside surface of barrel 30 comprises threads 120.

In the example embodiment shown in FIG. 2B, barrel 30 is twenty-four inches (24″) in length and has an outer diameter of eleven inches (11″). The thickness of wall 210 is one-half inch (½″).

Barrel 30 further comprises one or more circumferential notches (such as notches 212 and 214) cut into wall 210.

FIG. 2C is a detailed view of region B of FIG. 2B.

FIG. 2D is a detailed view of region C of FIG. 2B.

FIG. 2E is a schematic illustrating thread geometry 200 suitable for extracting fine gold from black sand. The geometry of threads 120 on inside surface 110 of barrel 30 has a significant effect on the ability of apparatus 100 to separate fine gold from black sand. The geometry of threads 120 comprises width, height and shape.

Threads 120 of FIG. 1 can be created by forming ribs 242 of FIG. 2E on inside surface 110 of barrel 30. FIG. 2E shows three example adjacent ribs 242A through 242C of substantially the same geometry as one another. Each of ribs 242A through 242C has a base of substantially equal width W and a substantially equal height H. Ribs 242A through 242C define threads 244A through 244C. The geometry of threads 244A through 244C depends on width W, height H and angles 246A through 246C.

Thread geometry 200 further comprises an interface between each pair of adjacent ribs. For each pair of adjacent ribs formed by ribs 242A through 242C of FIG. 2E, there is a corresponding interface 248A through 248C respectively. In one embodiment, the interface between each pair of adjacent ribs (such as interface 248A between ribs 242A and 242B) has a radius of curvature of ten-thousandths of an inch (0.01″).

In one embodiment where barrel 30 has a length of approximately twenty-four inches (24″) and an outer diameter of approximately 11″, height H is approximately 0.125″, angles 246A through 246C each have a value of approximately sixty-eight degrees (68°), and the width d of the flat top of ribs 242A through 242C is approximately 0.03″. The width W is therefore approximately 0.339″.

FIG. 3 is an exploded schematic of a portion of apparatus 100 of FIG. 1 showing additional components in more detail. FIG. 3 illustrates leg spacer 4, cover 19, first angle plate 20, second angle plate 21, exit chute 22, control panel cover 23, and control plate 24.

FIG. 4 is an exploded schematic of a portion of apparatus 100 of FIG. 1 showing additional components in more detail. FIG. 4 illustrates frame assembly 1, rigid caster 5, motor mount assembly 6, and rear strut assembly 18.

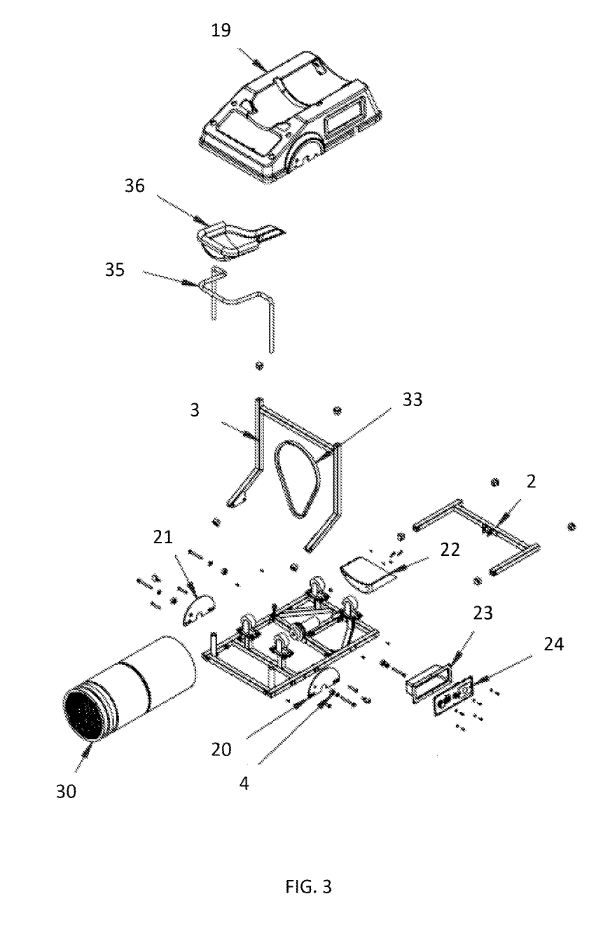

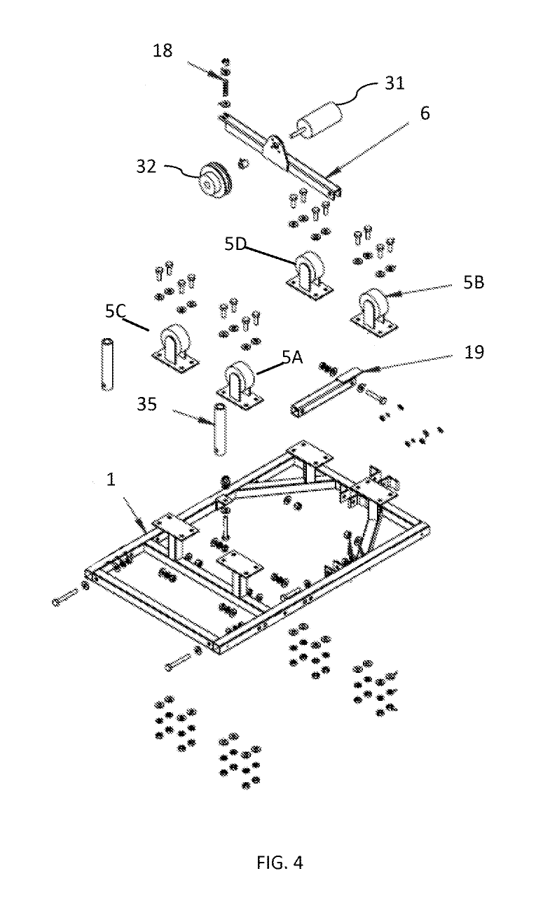

FIGS. 5 and 6 are perspective views of an apparatus for separating fine gold from black sand.

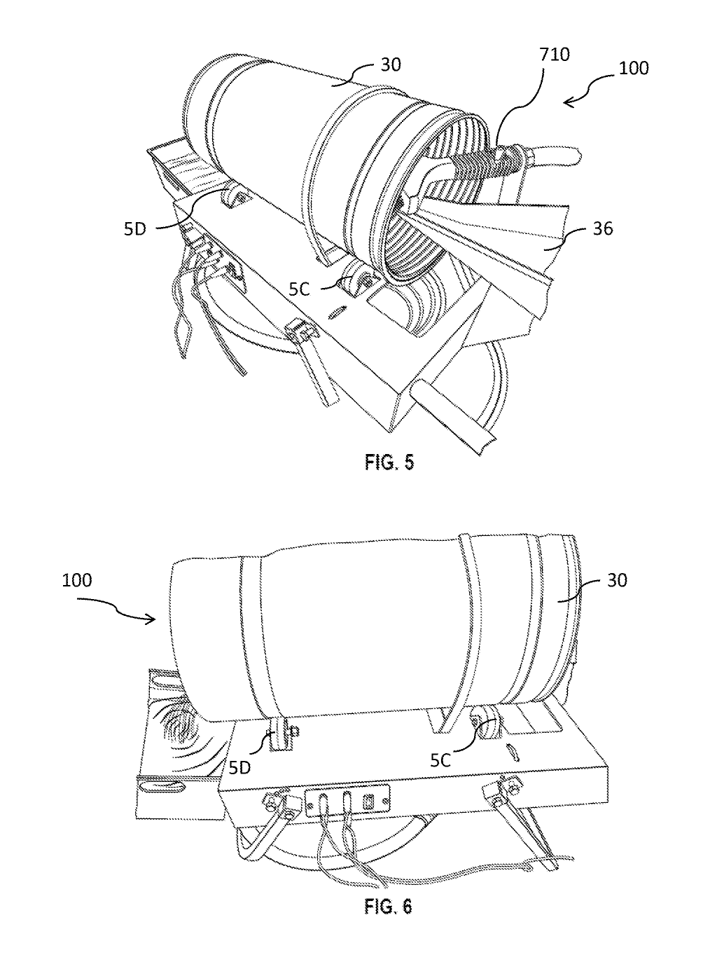

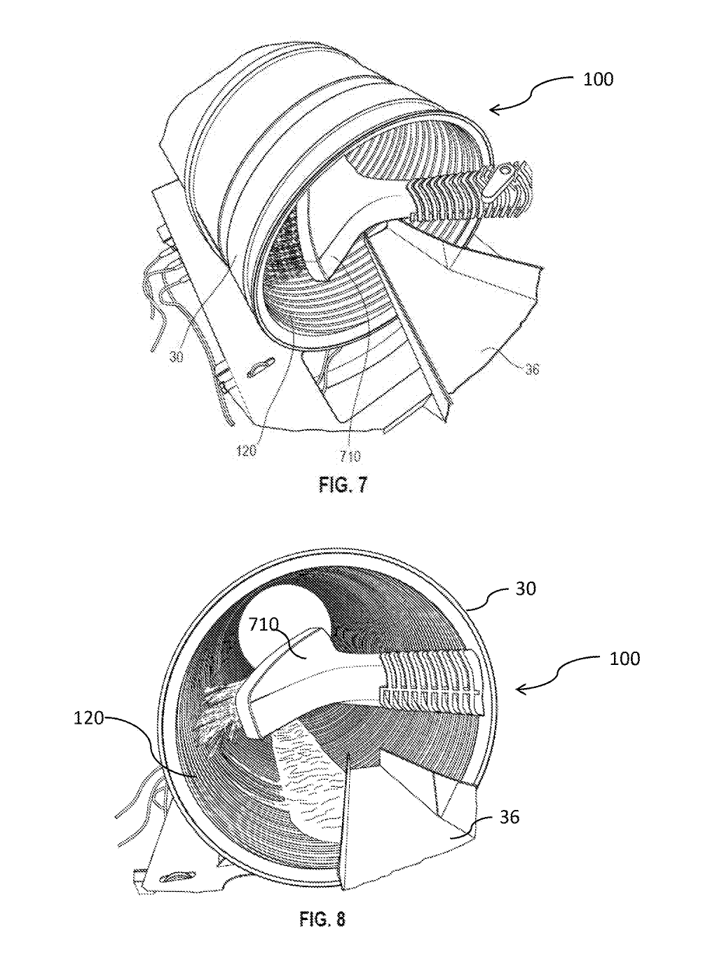

FIGS. 7 and 8 are close-up perspective views of an upper end of the apparatus of FIGS. 5 and 6.

Although the drawings of FIGS. 1, 3 through 8 depict different embodiments, it will be understood that the apparatuses of FIGS. 5 through 8 are substantially the same, with respect to the inventive aspects of the apparatuses and methods of operation, as apparatus 100 of FIG. 1. In the following paragraphs, the apparatuses of FIGS. 5 through 8 are referred to as apparatus 100 of FIG. 1.

Referring to FIG. 7, apparatus 100 comprises barrel 30, hopper 36 and threads 120. Apparatus 100 further comprises water spray nozzle 710. The location and direction of water spray nozzle 710 has a significant effect on the ability of apparatus 100 to separate fine gold from black sand.

During operation of apparatus 100, material is introduced into barrel 30 from hopper 36 at a position slightly lower than water spray nozzle 710. Threads 120 and water spray nozzle 710 can be configured to cause gold-bearing material introduced to barrel 30 via hopper 36 to be separated upon introduction. A line of gangue can form inside one or more of threads 120 on the lower side of water spray nozzle 710. Separated gold is carried in threads 120 to the upper rim of barrel 30 where it is collected, for example by allowing it to exit barrel 30 at the upper rim and drop down into a container.

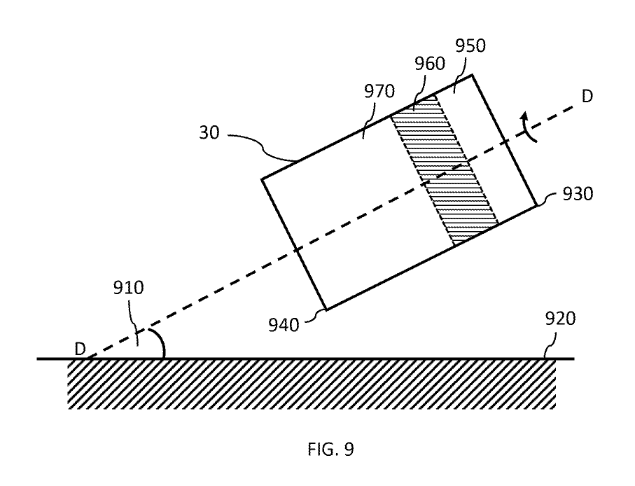

FIG. 9 is a schematic illustrating one position of water spray nozzle 710 of FIG. 7. The position and angle of water spray nozzle 710 can have a significant effect on the ability of apparatus 100 to separate gold from black sand.

FIG. 9 shows apparatus 100 with barrel 30 inclined at an angle 910 to a horizontal plane 920. Barrel 30 can be configured such that an axis of rotation D-D subtends angle 910 with horizontal plane 920. Angle 910 can vary depending on the type of material and the specific gravity of the material's constituents.

In one embodiment, when apparatus 100 is operating as a concentrator (for example, during the first phase of separation), angle 910 can have a value between twelve degrees (12°) and eighteen degrees (18°). In another or the same embodiment, when apparatus 100 is operating as a separator (for example, during the second phase of separation), angle 910 can have a value between eighteen degrees (18°) and twenty-five degrees (25°). In at least some embodiments, it has been found that apparatus 100 works better when angle 910 has a higher value for the purposes of separation than for concentration.

Angle 910 can be adjusted during operation of apparatus 100 based on its observed performance. Other parameters can also be adjusted; for example, the rate of flow of the water, the height of water spray nozzle 710 of FIG. 7 above the inside surface of barrel 30, and the angle of water spray nozzle 710 relative to barrel 30.

In operation, barrel 30 rotates about its longitudinal axis D-D. Referring again to FIG. 9, upper rim 930 of barrel 30 can be configured to allow fine gold particles emerging from upper rim 930 to drop down into a container (not shown in FIG. 9). Unwanted materials, such as black sand and the like, emerge at a lower rim 940 of barrel 30.

For the purposes of illustration and explanation, barrel 30 can be divided along its length into three regions 950, 960 and 970.

In an example embodiment, water spray nozzle 710 of FIG. 7 can be positioned inside barrel 30 such that water from water spray nozzle 710 can be directed at threads 120 in region 960. Water from water spray nozzle 710 can be directed at the side of barrel 30 by which it is understood to mean that water is directed at an angle to longitudinal axis D-D of barrel 30, and between the floor and the ceiling of barrel 30. In one embodiment, the angle can be approximately sixty degrees (60°).

Gold-bearing material can be introduced into threads 120 in region 960, at or slightly lower than water spray nozzle 710. Fine gold can be separated and carried by threads 120 through region 950 to upper rim 930. Black sand and other unwanted material can be separated and washed down via threads 120 through region 970 to lower rim 940.

In some embodiments, apparatus 100 of FIG. 1 can be operated continuously. A benefit of apparatus 100 over sluice boxes and batch concentrators is that it does not require cleaning during normal operation.

Hopper 36 can be designed to introduce gold-bearing material at a suitable position in barrel 30 where separation can begin in threads 120. A suitable position is just below water spray nozzle 710 of FIG. 7. Hopper 36 can also be designed to introduce the material diagonally into the tube so that the material is instantly washed allowing heavier specific gravity particles to work their way to the bottom of threads 120.

Apparatus 100 can be operated from a variety of power sources including a 12 volt power supply. The power supply can run motor 31 (shown in FIG. 3) and water pump (not shown in FIGS. 1, 3 and 4).

In some embodiments, the color of barrel 30 of FIG. 1 can be blue or another color that aids in the separation of fine gold from black sand in barrel 30, by allowing the difference between the two types of materials to be readily seen.

Apparatus 100 of FIG. 1 can be configured to concentrate and separate fine gold from black sand.

Using an embodiment of an apparatus for separating fine gold from black sand similar to apparatus 100 described in reference to FIGS. 1, 3 and 4, the following results were obtained in testing. When gold-bearing material pre-screened to one inch minus (material of size 1″ or less) was introduced into the apparatus, it was able to separate and recover gold within the gold-bearing material at a recovery rate of 99.4% for gold particles larger than 35 microns, and at a recovery rate of 99.9% for gold particles larger than 75 microns.

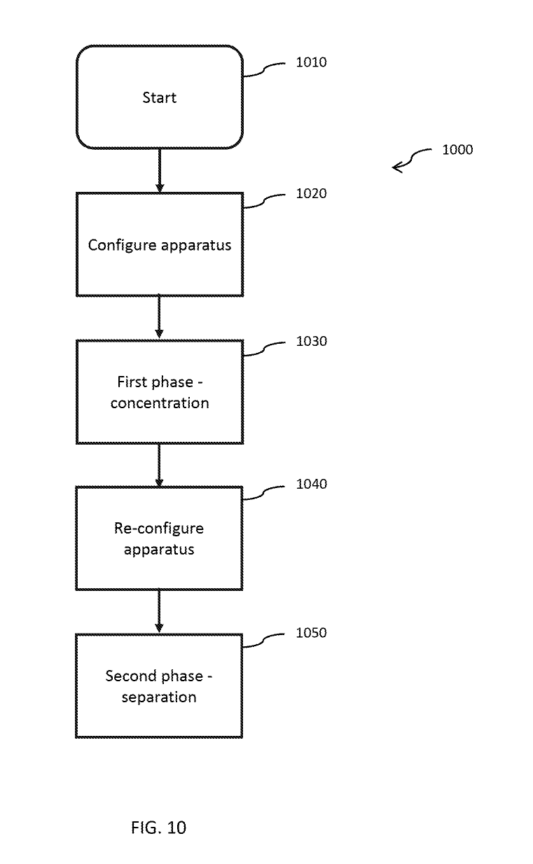

FIG. 10 is a flow chart illustrating method 1000 for separating fine gold from black sand. Method 1000 can involve the following steps. Method 1000 starts at step 1010, and proceeds straight to step 1020. At step 1020, apparatus 100 of FIG. 1 is configured for operation. In one embodiment, configuration includes setting barrel 30 at a suitable angle to the horizontal and setting barrel 30 in rotation at a suitable and essentially constant rotation speed about its longitudinal axis. It should be noted that in some embodiments the rotation speed can vary.

When apparatus 100 is configured for concentration, method 1000 proceeds to step 1030. At step 1030, gold-bearing material pre-screened to one inch minus is introduced into hopper 36 of apparatus 100. The gold-bearing material moves and/or is washed by a stream of water from hopper 36 to barrel 30. Once in barrel 30, the material is washed and displaced into threads 120 on the inside surface 110 of barrel 30. In an example embodiment, threads 120 comprise eight starts at upper rim 130 of barrel 30.

Threads 120 on inside surface 110 of barrel 30 act to pull material with a relatively high specific gravity towards upper rim 130 of barrel 30. Material with a relatively high specific gravity falls to the bottom of threads 120 while material with a relatively low specific gravity is washed over the ribs and down barrel 30 towards the lower rim (not shown in FIG. 1) of barrel 30. Material arriving at the lower rim of barrel 30 can be expelled as waste material.

Apparatus 100 can be configured such that water flow in the middle to lower portion of barrel 30 (for example, region 970 of FIG. 9) is suitable for washing material with relatively low specific gravity to lower rim 940 of barrel 30. Apparatus 100 can be further configured such that water flow in the vicinity of a water spray nozzle (such as water spray nozzle 710 of FIG. 7) is sufficient to allow only material with relatively high specific gravity to move towards upper rim 930 of barrel 30.

In some embodiments, apparatus 100 can be configured such that material with a specific gravity value less than four (4) remains in barrel 30 or is expelled at lower rim 940 of barrel 30. Configured this way, material with a specific gravity value of four (4) or higher moves to upper rim 930 of barrel 30 and is recovered for input to a second phase of the method known as separation.

In one embodiment, apparatus 100 can be configured for the first phase by setting the angle 910 (shown in FIG. 9) subtended by the axis of rotation of barrel 30 with the horizontal plane to a value between twelve degrees (12°) and eighteen degrees (18°).

When the concentration phase is complete or essentially complete, the method proceeds to step 1040—the second phase—also known as separation. At step 1040, apparatus 100 is configured such that angle 910 (shown in FIG. 9) subtended by the axis of rotation of barrel 30 with the horizontal plane to a value between eighteen degrees (18°) and twenty-five degrees (25°). Typically, apparatus 100 is configured in step 1040 such that angle 910 of FIG. 9 has a higher value during step 1050 (separation) than during step 1030 (concentration).

Gold-bearing material recovered at the end of step 1030 (from concentration) is fed into hopper 36 and enters barrel 30. In one embodiment, barrel 30 is configured to rotate in a clockwise direction about its longitudinal axis D-D. Threads 120 on inside surface 110 of barrel 30 move in a counter-clockwise as barrel 30 rotates.

In a manner similar to step 1030, material with relatively low specific gravity is washed by a suitably configured flow of water from water spray nozzle 710 of FIG. 7 towards lower rim 940 of barrel 30.

Material with relatively high specific gravity falls to the bottom of threads 120, and is brought towards upper rim 930 of barrel 30 by rotation of barrel 30. Water flow rate in the vicinity of water spray nozzle 710 of FIG. 7 can be configured to discourage material with relatively low specific gravity from moving towards upper rim 930 of barrel 30. Material with relatively low specific gravity typically comprises black sand, magnetite, lead or other similar material.

Apparatus 100 can be configured as described above such that only gold is able to move to upper rim 930 of barrel 30 for recovery. Gold has specific gravity of approximately 19.4 which is generally the highest specific gravity of constituents of the gold-bearing material.

In an example embodiment, the rotational speed of barrel 30 can have a value between eighteen (18) revolutions per minute (rpm) and twenty-two (22) rpm.

In one embodiment, in operation, barrel 30 rotates clockwise about its longitudinal axis D-D when viewed from the upper rim of barrel 30, and the ribs formed on inside surface 110 of barrel 30 are left-hand cut.

In another embodiment, in operation, barrel 30 rotates counter-clockwise about its longitudinal axis D-D when viewed from the upper rim of barrel 30, and the ribs formed on inside surface 110 of barrel 30 are right-hand cut.

In each of the above embodiments, rotation of barrel 30 acts to move material (such as separated fine gold) in the bottom of threads 120 to the upper end of barrel 30. Unwanted material is washed down to the lower end of barrel 30.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. An apparatus for separating a target element from a mixed material, said apparatus comprising:
a. a barrel with an inside surface, said inside surface with at least one seamless helical thread extending from an upper rim of said barrel to a lower rim of said barrel;
b. a drive mechanism for rotating said barrel about a longitudinal axis, said longitudinal axis inclined at an angle to the horizontal, said upper rim positioned to be higher than said lower rim;
c. a hopper configured to introduce said mixed material into said barrel; and
d. a water spray nozzle positioned to introduce a continuous stream of water onto said inside surface of said barrel,
wherein the handedness of said at least one seamless helical thread and the direction of rotation of said barrel are selected to move said target element toward said upper rim of said barrel.

2. The apparatus of claim 1 wherein said drive mechanism is configured to rotate said barrel at a rotational rate of between eighteen revolutions per minute and twenty-two revolutions per minute.

3. The apparatus of claim 1 wherein said angle is between twelve degrees and twenty-five degrees.

4. The apparatus of claim 1 wherein said angle can be adjusted during operation of said apparatus.

5. The apparatus of claim 1 wherein said target element is gold.

6. The apparatus of claim 1 wherein the specific gravity of said target element is greater than four.

7. The apparatus of claim 1 wherein said inside surface of said barrel comprises a plurality of substantially identical seamless helical threads extending from said upper rim of said barrel to said lower rim of said barrel.

8. The apparatus of claim 1 wherein said inside surface of said barrel comprises eight substantially identical seamless helical threads, each extending from said upper rim of said barrel to said lower rim of said barrel.

9. The apparatus of claim 1 wherein said barrel is a color, said color selected to contrast with the color of said target element and the color of said mixed material.

10. The apparatus of claim 1 wherein said barrel is formed by CNC machining.

11. The apparatus of claim 1 wherein said at least one seamless helical thread is defined by a helical rib protruding from said inside surface of said barrel, said helical rib comprising:
a. a first surface substantially perpendicular to said inner surface of said barrel; and
b. a second surface subtending an angle of approximately sixty-eight degrees with said inside surface of said barrel.

12. The apparatus of claim 1 wherein said water spray nozzle is oriented to direct said continuous stream water at said inside surface of said barrel between the floor and ceiling of said barrel and at an offset angle from said longitudinal axis.

13. The apparatus of claim 12 wherein said offset angle is approximately sixty degrees.

14. A method for operating the apparatus of claim 1, the method comprising:
a. adjusting said angle to a first angle of inclination;
b. activating said drive mechanism to cause said barrel to rotate at a substantially constant rotational rate;
c. introducing said continuous stream of water from said water spray nozzle;
d. introducing a quantity of said mixed material into said barrel via said hopper, said mixed material introduced into said continuous stream of water; and
e. recovering a concentrate discharged at said upper rim,
wherein said concentrate contains said target element at a higher concentration than said mixed material.

15. The method of claim 14 further comprising:
f. adjusting said angle to a second angle of inclination;
g. re-introducing said concentrated mixed material into said barrel via said hopper, said concentrated mixed material introduced into said stream of water; and
h. recovering said target element at said upper rim.

16. The method of claim 15 wherein said first angle of inclination is between twelve degrees and eighteen degrees and said second angle of inclination is between eighteen degrees and twenty-five degrees.
